(19) United States
(12) Patent Application Publication
(10) Pub. No.: US 2009/0122523 A1
(43) Pub. Date: May 14, 2009

(54) Drinking Vessel With Light Source

(76) Inventor: Kendall Peter Rycroft, Dalton, GA (US)

Correspondence Address: AKERMAN SENTERFITT, 8100 BOONE BOULEVARD, SUITE 700, VIENNA, VA, 22182-2683, US

(21) Appl. No.: 11/794,363

(22) PCT Filed: Dec. 29, 2005
(86) PCT No.: PCT/US05/47195

§ 371 Date: Mar. 27, 2008

Related U.S. Application Data
(60) Provisional application No. 60/639,775, filed on Dec. 29, 2004.
(60) Provisional application No. 60/661,517, filed on Mar. 15, 2005.
(60) Provisional application No. 60/672,881, filed on Apr. 20, 2005.

(51) Int. Cl. F21V 33/00

(52) U.S. Cl. 362/101

(57) ABSTRACT

A drinking vessel including a housing having an inner (204) and an outer shell (203), and at least one handle (202) disposed on the outer shell (203), light projection means (206) disposed on the handle (202) for projecting beam of light to the exterior of the housing, ans a pressure sensor (205) positioned between the inner and the outer shells (204, 203). When the weight is detected by the pressure sensor (205), a switch is activated to turn the light projection means (206) ON. The light beam shines through a lens portion at the base of the handle (202). A picture slide may be disposed in the lens portion, so that an image on the slide is projected by the light projection means (206). A musical apparatus may be also actived by the switch.

The present application claims priority from U.S. Provisional Patent Application Nos. 60/639,775, filed Dec. 29, 2004, 60/661,517, filed Mar. 15, 2005, and 60/672,881, filed Apr. 20, 2005, the contents of which are incorporated by reference herein in their entirety.

### BACKGROUND OF THE INVENTION

1. Field of the Invention

The present invention relates to a drinking vessel which can project images or a beam of light onto a remote surface when the vessel is filled with a liquid or other substance.

2. Description of Related Art

Different types of drinking vessels have been used for entertainment purposes. Coffee mugs, baby bottles, and other beverage containers are commonly personalized with specialized greetings, photographs and the like.

Drinking vessels which include a light source are also known in the art, for example U.S. Pat. No. 6,379,018.

However, a drinking vessel that is able to be used for entertainment and for illumination, would be both novel and advantageous to the public.

### SUMMARY OF THE INVENTION

The present invention relates to a drinking vessel that provides entertainment for the user and also serves an illumination device when the drinking vessel is filled with liquid or another substance. In another embodiment, the vessel can be used as a flashlight.

In one embodiment consistent with the present invention, the drinking vessel includes a molded inner and molded outer shell, having at least one handle on the side wall of the outer shell for the user to hold the vessel. The inner and outer shells are fitted together and are sealed to provide waterproofing. A pressure sensor is positioned on the underside of the bottom surface of the inner shell.

The pressure sensor detects the presence of a liquid or other substance, based on weight, in the central cavity the vessel. When a weight is detected, a switch in a battery and light assembly, is activated to turn on a light source disposed in at least one handle of the vessel. The light source shines through a transparent lens portion at the base of the vessel onto a remote surface.

In another embodiment consistent with the present invention, a picture slide is disposed in a recessed portion above the lens portion, so that an image on the slide can be projected onto a remote surface by the light beam of the light source.

In yet another embodiment consistent with the present invention, the switch in the battery and light assembly can lead to an external switch on the external wall of the handle of the drinking vessel, so that the light source can be turned “ON/OFF” manually. In this embodiment, for example, the vessel can be used as a flashlight.

In another embodiment consistent with the present invention, music can be played from a musical apparatus through a speaker in the handle. Further, in another embodiment consistent with the present invention, indicator lights can be used to show predetermined periods of time have passed.

Finally, in one embodiment consistent with the present invention, the materials used in the vessel would primarily include a plastic or composite material for the inner and outer shells, and the handle(s). These materials would be well-known to one of ordinary skill in the art.

Thus has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIGS. 1A and 1B are side views of drinking vessels according to various embodiments consistent with the present invention.

FIG. 2 shows a side sectional view of the drinking vessel according to one embodiment consistent with the present invention.

FIG. 3 shows an exploded perspective view of the handle of the drinking vessel according to one embodiment consistent with the present invention.

FIGS. 4A-4D show magnified perspective and partially sectional views of the base portion of the handle of the drinking vessel according to various embodiments consistent with the present invention.

FIG. 5 shows a magnified view of the base portion of the handle of the drinking vessel according to another embodiment consistent with the present invention.

FIG. 6 shows a sectional side view of the base portion of the handle of the drinking vessel according to another embodiment consistent with the present invention.

FIG. 7 shows a sectional side view of the handle of the drinking vessel according to another embodiment consistent with the present invention.

### DESCRIPTION OF THE INVENTION

The present invention relates to a portable, drinking vessel assembly, which contains an illumination device and can serve as entertainment for the user by projecting images onto a remote surface for predetermined periods of time; the illumination which can also be used as a flashlight. In addition, music can be played from the drinking vessel.

The drinking vessel assembly can be of any type and configuration, such as a cup, mug, baby bottle, children's “sippy” cup, etc., and is normally circular in shape with a central cavity therein for holding the liquid. The illumination device is placed in the handle of the vessel, as well as the musical apparatus, if any.

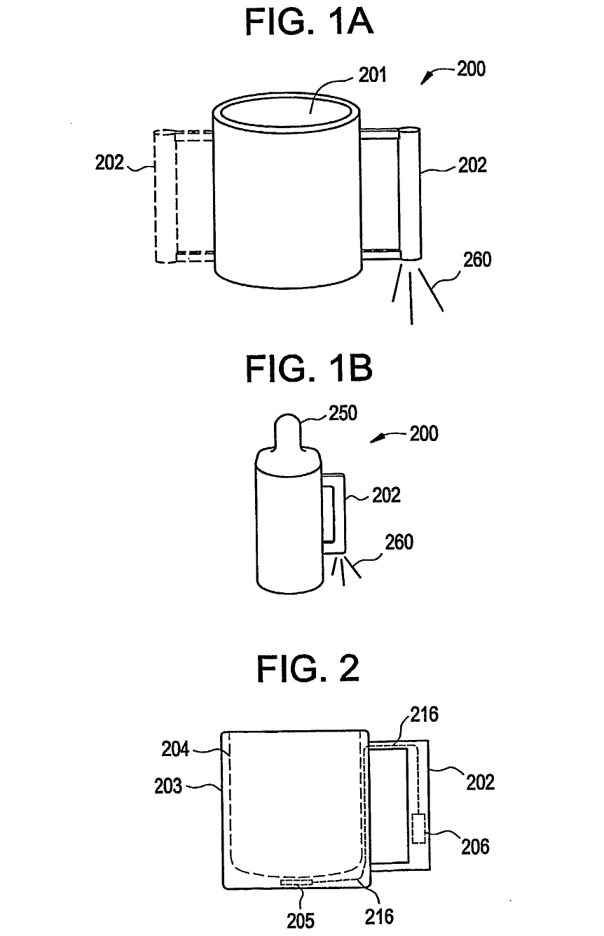

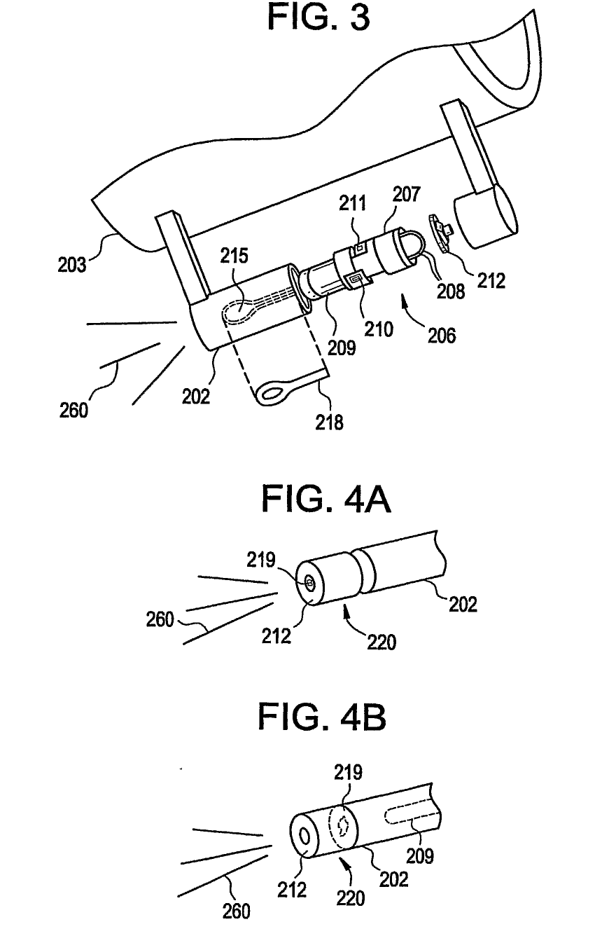

More specifically, in one embodiment consistent with the present invention, the housing of a drinking vessel 200 (see FIG. 1A) is circular in shape, for example, and includes a central cavity 201 for holding a liquid or other substance. At least one handle 202 is provided on the drinking vessel 200, and if the drinking vessel 200 is a children's cup, then two handles 202 may be provided. Further, if the drinking vessel 200 is a baby bottle, a cap with nipple 250 may be provided on the drinking vessel 200, in addition to at least one handle 202 (see FIG. 1B).

As shown in FIG. 2 in a sectional view of the drinking vessel 200 (shown with one handle 202 for sake of convenience), the vessel 200 includes a molded outer shell 203, and a molded inner shell 204. The outer and inner shells 203, 204 fit together and are sealed by heating or by an adhesive or any other means to ensure that the seal is waterproof.

In one embodiment, at least one handle 202 can be applied using an adhesive, thermal bonding, or other adhering means, on a side wall of the outer shell 203. In one embodiment, the outer and inner shells 203, 204 as well as the handle 202 are made of a plastic or composite material for ease of molding and shaping. The material may be transparent at any portion of the drinking vessel 200, or may be opaque, or designed in any pattern, or any combination of the above.

In one embodiment consistent with the present invention, a pressure sensor 205 is used to turn on the light projection means 206. The pressure sensor 205 is positioned on the underside of the bottom surface of the inner shell 204. The sensor 205 is connected to the light projection means 206, including at least a battery and light assembly disposed in the handle 202 of the drinking vessel 200, via a wire 216.

The battery and light assembly includes a battery holder 207 which houses at least one battery 208 (such as a Lithium battery) of an appropriate size and capacity to ensure powering of the drinking vessel 200 for at least a few hours before replacement is required. The battery and light assembly includes a switch 210 and can also include a timing assembly 211. A light bulb acts as a light source 209 to provide beams of light 260.

A cap 212 fits over the battery holder 207, in a press-fit, and protects the batteries 208. The cap 212 is inserted into the internal recess of the handle 202 using a press-fit or other fitting means.

The battery and light assembly includes a power button switch 210 which turns the power to the light source (i.e., bulb) 209 “ON/OFF”.

However, in one embodiment of the present invention, a timing assembly 211 (i.e., a timer connected to the batteries 207, light source 209, and switch 210) is included in the handle 202, and thus, there may be no need for an “OFF” switch (since the light turns off after a predetermined period of time). The battery and light assembly includes a power button switch 210 which turns the power to the light source (i.e., bulb) 209 “ON/OFF”.

An aperture 215 with grooved edges is disposed in the base portion of the handle 202, allowing access to the switch 210, which projects through the aperture 215. A switch cover 218 is disposed in the aperture 115, and is made of a thin rubber-like material, which allows the user to easily access and press the switch 210 through the cover 218. However, in an alternative embodiment, this piece 218 may be eliminated, and the switch 210 can be made to project through the base portion of the handle 202 for direct external access by the user.

In one embodiment consistent with the present invention, the drinking vessel 200 includes a transparent lens portion 212 at the bottom surface of the handle 202 of the vessel 200, such that the light 260 from light source 209 can shine through the lens portion 212 onto a remote surface. The lens portion 212 may be made of a plastic and may also be of different colors as well as being clear. In one embodiment, the light source 209 acts like a flashlight.

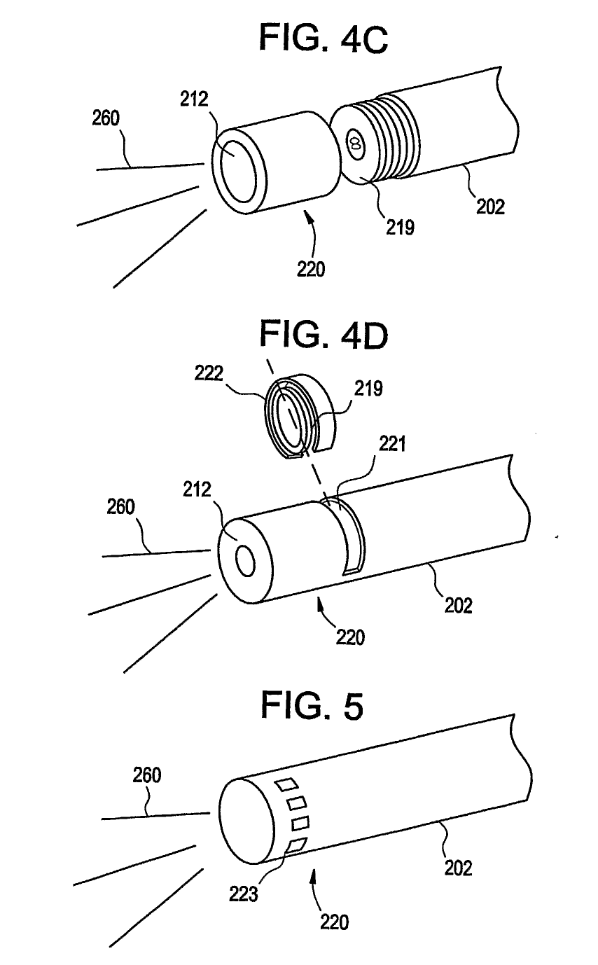

In another embodiment consistent with the present invention, the light beam from the light source 209 can project a picture or icon 219 through the transparent lens portion 212 onto a remote surface. The picture or icon 219 can be on the lens portion 212 are can be a separate slide 219. The method of accomplishing this projection can vary, but in one embodiment, can include, for example, at least the embodiments described in FIGS. 4A-4D.

As shown in FIG. 4A, the base portion 220 of the handle 202 contains a lens portion 212 as a picture slide 219 and has a picture disposed therein. The base portion 220 can be press-fitted or screw-fitted onto the handle 202. When a beam 260 of light from the battery and light assembly is shown through the base portion 220 and the slide 219, the resulting image on the slide 219 is projected onto a remote surface. When the user wishes to change the picture slide 219, the base portion 219 can be disconnected and another base portion 220 with a different picture slide 219 connected thereto.

In another embodiment consistent with the present invention, FIG. 4B shows a base portion 220 including a lens portion 212 of the handle 202. A slide 219 with a picture therein, is disposed within the base portion 220, and secured by flanges or other securing means, so as not to move or slide within, when it is disposed in the base portion 220. In this embodiment, the slide 219 is permanently disposed in the base portion 220. The light beam 260 from the light source 209 would project the image from the slide 219 through the lens portion 212 onto a remote surface.

In yet another embodiment consistent with the present invention, FIG. 4C shows the base portion 220 including a lens portion 212 disposed at a distal end of the handle 202. The transparent lens portion 212 can be permanently secured into the handle 202, or can be press-fitted or snap-fitted, or secured by any other means, at the base of the handle 202. The slide 219 is disposed in a distal portion of the main body of the handle 202, and the base portion 220 of the handle 212 can be removably screwed on/off of the handle 202.

In yet another embodiment consistent with the present invention, FIG. 4D shows an exploded view of a portion of the base portion 220 of a handle 202. A slot-like portion 221 is disposed in the handle 202, and a picture slide 219 having a picture or icon thereon, is disposed in the slot-like portion 221. The picture slide 219 may be of any shape desired, but preferably corresponds to the shape of the slot-like portion 221 (i.e., circular). The slot-like portion 221 may include a rubber insert 222, for example, or other means to close the opening of the slot-like portion 221 and secure the picture slide 219 therein. The user can remove the insert 124 and change the slide 120 within the slot 123 from time to time as the user wishes. As stated above, the light beam from the light source 209 would project the image from the slide 219 through the lens portion 212 onto a remote surface.

Although a number of different embodiments have been described, it would be apparent to one of ordinary skill in the art that other structural designs are possible and well within the skill of one in the art. For example, other embodiments of disposing the picture slide 219 into the base of the handle 202 of the vessel 200 would be apparent to one of ordinary skill in the art.

In addition, although the above features are described as being disposed in one handle 202 of the vessel 200, one of ordinary skill in the art would recognize that the features could be disposed in two handles 202 of the vessel 200, or in other parts of the vessel 200, such as between the inner and outer shells 203, 204.

In operation, the pressure sensor 205 detects the weight of a liquid or other substance when poured or placed into the vessel 200, and activates a switch 210 in the battery and light assembly which turns the light source 209 “ON”. When the weight is removed (i.e., the liquid is poured out of the cavity 201), the pressure sensor 205 will detect the reduction in weight, and the switch 210 will automatically turn the light source 209 “OFF”.

In another embodiment consistent with the present invention, a timer 211 is connected to the sensor 205, batteries 208, light source 209, and ON/OFF switch 210, and the light source 209 can be turned “OFF” automatically after a predetermined period of time (i.e., one or two minutes).

Further, the timer 211 allows the light source 209 to turn ON for a predetermined period of time—such as two minutes. If not turned OFF by the switch 210, the timer 111 would simply turn OFF after that predetermined period of time. Accordingly, even if the vessel 200 is empty, the light source 209 can be turned “ON”, or the light source 209 can be turned “OFF” even though the vessel 200 is full. Thus, in this embodiment, for example, the vessel 200 can be used as a flashlight.

In another embodiment consistent with the present invention, the exterior of the base portion 220 of the handle 202 may contain at least one indicator light 223 (i.e., an LED) which indicates how long the light source 209 has been ON (see FIG. 5). For example, as shown in FIG. 5, the base portion 220 may have four indicator lights 223, each one of the same or a different color, which will light up when the light source 209 is turned ON, and which will turn OFF individually after a predetermined amount of time has passed—i.e., 30 seconds. Thus, after two minutes have passed, the lights 223 will have all turned OFF. Of course, the lights 223 can each turn ON after a predetermined period of time, rather than OFF.

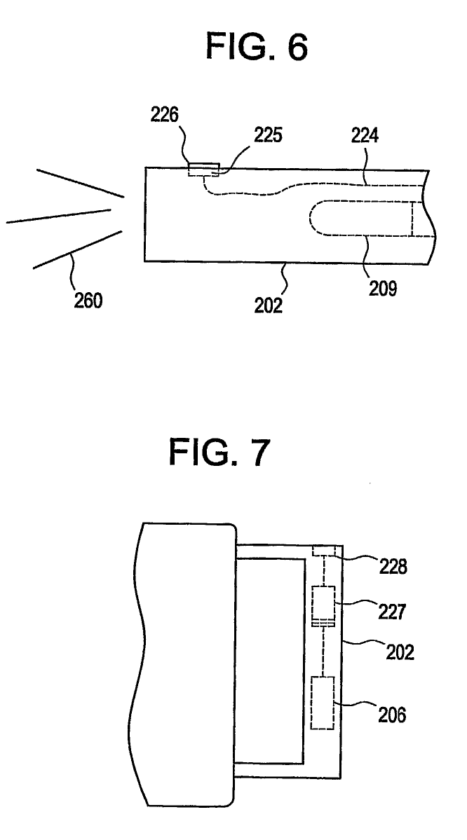

A side view of the base portion 220 of the handle 202 in FIG. 6, shows the wires 224 which extend from the timing assembly 211 to the LEDs 225. The LEDs 225 are visible via apertures in the base portion 220 of the handle 202, and may be covered by a transparent cover 226. Of course, one of ordinary skill in the art would recognize that any shape or positioning of indicator lights may be used in the handle 202 of the vessel 200 for indicating the passage of time to the user.

Thus, in operation—either when the pressure sensor 205 detects a weight in the vessel 200, or when the external switch 210 is used—when the light source 209 is turned “ON”, the light will shine through a lens portion 212, and/or a picture slide 219, projecting a light and/or an image onto a remote surface. If a picture slide 219 is used, and the user wishes to change the picture slide 219, the picture slide 219 can be replaced with a different picture slide 219.

In another embodiment consistent with the present invention, music can be played when the light source 209 is turned ON/OFF by activation of the pressure sensor 205, or can be turned ON/OFF using the external switch 210. The music is recorded in a memory which is part of a chip 227 disposed in the handle 202 (see FIG. 7). The chip 227 is connected to a speaker 228, which is disposed in the handle 202 of the vessel 200, and is connected to the switch 210 and powered by the battery 208. The musical apparatus can be in addition to the light projection means 206 disclosed earlier.

Although a number of different embodiments have been described, it would be apparent to one of ordinary skill in the art that other structural designs are possible, or any combination of the above embodiments is possible, and well within the skill of one in the art.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A vessel comprising:
a housing having an inner shell and an outer shell;
at least one handle disposed on said outer shell of said housing; and
a light source disposed in said handle, which projects a beam of light externally of the housing.

2. The vessel according to claim 1, further comprising:
a switch which turns said light source on and off.

3. The vessel according to claim 2, further comprising:
a pressure sensor disposed between said inner shell and said outer shell.

4. The vessel according to claim 3, further comprising:
a switch connected to said pressure sensor, said switch which activates said light source when said pressure sensor detects a substance in said vessel.

5. The vessel according to claim 2, further comprising:
a battery holder connected to said light source, said battery holder which holds at least one battery.

6. The vessel according to claim 5, further comprising:
a timer connected to said switch.

7. The vessel according to claim 5, further comprising:
a plurality of indicator lights disposed on said handle which are turned ON/OFF by said switch.

8. The vessel according to claim 5, further comprising:
a lens portion disposed in said base of said handle, through which said light beam is projected.

9. The vessel according to claim 8, wherein said lens portion is one of transparent and has a color.

10. The vessel according to claim 8, further comprising:
a slide disposed in said base of said handle, through which said beam projects, said slide having a picture disposed thereon such that said picture is projected externally of the housing.

11. The vessel according to claim 6, wherein said timer activates said switch which activates said light source for a predetermined period of time.

12. The vessel according to claim 10, wherein said slide is interchangeable.

13. The vessel according to claim 5, further comprising:
a musical apparatus connected to said at least one battery, said musical apparatus including a speaker for projecting a musical sound.

14. The vessel according to claim 13, wherein said musical apparatus is turned ON/OFF by said switch.

15. The vessel according to claim 4, further comprising:
a musical apparatus disposed in said handle, which is turned ON/OFF by activation/deactivation of said pressure sensor.

16. A vessel comprising:
a housing having an inner shell and an outer shell;
a handle disposed on said outer shell;
means disposed in said handle, for activating a light source to project an image externally of said housing.

17. The vessel according to claim 16, further comprising:
means for projecting said light beam for predetermined periods of time.

18. The vessel according to claim 17, further comprising:
a slide having said image thereon, through which said light beam is projected, such that said image is projected externally of said housing.

19. The vessel according to claim 16, further comprising:
a musical apparatus including a speaker, which projects a musical sound from said housing.

20. The vessel according to claim 17, further comprising:
a switch for turning at least said light source projection means ON/OFF.

21. The vessel according to claim 19, further comprising:
a switch for turning at least said musical apparatus ON/OFF.

22. The vessel according to claim 16, further comprising:
a plurality of indicator lights disposed on said handle.
